(19) United States
(12) Patent Application Publication
(10) Pub. No.: US 2009/0004067 A1
(43) Pub. Date: Jan. 1, 2009

(54) CANDLE WITH REMOVABLE SEAL FOR DISPENSING AIR TREATMENT CHEMICAL

(76) Inventors: Paul E. Furner, Racine, WI (US); Murthy S. Munagavalasa, Racine, WI (US); Carl R. Schwartz, Okauchee, WI (US)

Correspondence Address: S.C. JOHNSON & SON, INC., 1525 HOWE STREET, RACINE, WI, 53403-2236, US

(21) Appl. No.: 11/770,038

(22) Filed: Jun. 28, 2007

(51) Int. Cl. B32B 27/04

(52) U.S. Cl. 422/126

(57) ABSTRACT

Candles are provided with a band on a wall of their outer housing for sealing an air treatment chemical placed adjacent the housing. The candle includes a housing containing a combustible fuel. An air treatment chemical is mounted on a radially outward portion of the housing in a position where it can be heated through a side wall of the housing by the fuel when it is combusted. A seal is positioned over the air treatment chemical to inhibit dispensing of the air treatment chemical prior to combustion of the fuel, and is removable to permit the air treatment chemical to be dispensed when the fuel is combusted.

### CROSS-REFERENCE TO RELATED APPLICATIONS

Not applicable.

### STATEMENT REGARDING FEDERALLY SPONSORED RESEARCH/DEVELOPMENT

Not applicable.

### BACKGROUND OF THE INVENTION

The present invention relates to candles that dispense an air treatment chemical. More particularly, it relates to the use of a peel-off strip that can be removed to expose an air treatment chemical, thereby permitting the air treatment chemical to be dispensed when the candle is combusted.

A variety of devices are known for dispensing volatilizable air treatment chemicals. Such air treatment chemicals may be air scents or deodorizers (e.g., fragrances or masks), pest control materials (e.g., insecticides, insect repellants, or insect growth control regulators), allergen control ingredients, disinfectants, or other materials.

In some of these devices, the air treatment chemical is mixed with candle wax and is dispensed during the burning process, the chemical usually being released primarily from the heated wax surrounding the wick rather than from the wax as it combusts. While this is a common technique for dispensing a variety of fragrances, for various reasons it has been less successful for the dispensing of pest control materials. Further, the walls of the candleholder may restrict the ability of the air treatment chemical quickly to disperse in some configurations.

There have been attempts to place separate sources of air treatment chemicals inside a candle structure to use the heat of the candle to dispense the chemical, without exposing the air treatment chemical to burning. See, for example, U.S. Pat. Nos. 2,775,006, 2,918,750, 3,898,039 and 5,891,400. The disclosure of these patents and of all other publications referred to herein are incorporated herein by reference as if fully set forth herein. However, various attempts relied on restricted dispersion through a constrained opening of the candle housing or the air treatment chemical was susceptible to undesired dispersion by being continuously exposed on the interior or exterior of the candle.

There have also been attempts to mount a separate air treatment source in a way that is not restricted by a candle housing, yet can use the heat of the candle to facilitate dispersion. For example see U.S. Pat. Nos. 2,254,906 and 6,290,914. However, such approaches could be cumbersome, difficult to install and use, and could become hot to the touch.

Moreover, many of the previous devices required the consumer to come into direct contact with the air treatment chemical during setup and use. It is desirable to minimize the contact and interaction between the consumer and the air treatment chemical, if only for aesthetic reasons. Finally, changing or replacing the air treatment chemical of some previous devices, if even possible, could be problematic.

Thus, there is a need for an improved candle systems, particularly where they are provided with an associated air treatment chemical source separate from the candle wax, which facilitates dispersion of a range of air treatment chemicals.

### BRIEF SUMMARY OF THE INVENTION

In one aspect the invention provides an article for dispensing an air treatment chemical having a housing with an exterior side wall and an internal cavity in which is positioned a combustible fuel. An air treatment chemical is mounted on a radially outward portion of the exterior side wall in a position where it can be heated through the side wall by the fuel when it is combusted.

If the air treatment chemical has a sufficiently low volatility at the anticipated storage temperatures, it may be unnecessary to provide a seal covering the chemical. However, if the air treatment chemical is sufficiently volatile that an excessive amount of the chemical would be lost in storage prior to use, the article can be held within a pouch or other container to prevent the premature loss of air treatment chemical. Preferably, if containment of the air treatment chemical prior to use is desired, a removable seal is positioned over the air treatment chemical to inhibit dispensing of the air treatment chemical prior to combustion of the fuel. Removing the seal permits dispensing of the air treatment chemical when the fuel is combusted.

Thus, an aspect of the invention could be an article for dispensing an air treatment chemical, where there is a housing having an exterior side wall structure and an internal cavity in which is positioned a combustible fuel. There would also be an air treatment chemical mounted on a radially outward portion of the exterior side wall structure in a position where it can be heated through the exterior side wall structure by the fuel when the fuel is combusted.

In preferred forms, the fuel is wax and the article is in a form of a candle.

In another preferred form, the air treatment chemical is selected from the group consisting of volatile insect control agents, volatile fragrances, and volatile deodorizers.

In still another preferred form, the fuel has mixed therein an air treatment chemical that is different from the air treatment chemical mounted on the radially outward portion of the exterior side wall structure. The air treatment chemical mixed in the fuel may be a fragrance and the air treatment chemical borne on the side wall may be an insect control agent.

In preferred forms, an air treatment chemical is applied to the exterior side wall structure by a printing process.

In another preferred form, the seal is in the form of a band having a peel-off portion. The band may have multiple layers, including an outer seal layer that is capable of peeling off from an inner layer, where the inner layer includes an air treatment chemical. Additionally, the air treatment chemical may be applied to the inner layer of the band by a printing process and the inner layer may include, on its inner side, an adhesive for mounting the band on the exterior side wall. The air treatment chemical of the inner layer may be an insect control agent.

In a preferred form, the housing is cylindrical. Additionally, the housing may be essentially rectangular in top view. Alternatively, the housing may be at least partially frustum-shaped.

In a further preferred form, the housing is partially surrounded by a sleeve to enhance the dispensing of the air treatment chemical when the fuel is combusted. Furthermore, the housing may be supported by a base.

In yet another preferred form, the seal includes a foil layer that may, if desired, be mechanically reinforced with a polyethylene terephthalate or other suitable plastic layer. Alternatively, polyethylene terephthalate by itself can provide a typically less complete but sometimes adequate seal.

In another aspect, the invention provides a kit for selectively treating air in a room with alternative air treatment chemicals. The kit includes a housing having an internal cavity in which is positioned a combustible fuel, and an exterior side wall. A first band and a second band are included, each having an air treatment chemical mounted on the band, the air treatment chemical on the first band being a different air treatment chemical than that on the second band. Both bands have a removable seal positioned over their respective air treatment chemical to inhibit dispensing of their air treatment chemical prior to combustion of the fuel. Removing the seal permits dispensing of an air treatment chemical when the fuel is combusted. The bands are alternatively positionable around the exterior side wall structure to be in a position where they can be heated through the side wall by the fuel when it is combusted.

It will be appreciated from the discussions above and below, and the enclosed drawings, that the present invention provides a way of letting a candle function as a conventional candle (with or without an air treatment chemical, such as a fragrance, mixed in the wax). It then also provides on its outer radial periphery a source of a selected air treatment chemical.

The air treatment chemical is covered during shipment and is exposed immediately prior to use. The air treatment chemical may be on an integral outer surface of the candle housing, or may be combined with a layer of a multiple layer band.

The device is inexpensive to produce and reliable. Optionally, an air treatment chemical containing band may be configured so that it can be dropped down over the candle housing by a consumer. Thus, if a consumer is in the mood for pine scent, they can select a band that achieves that. If they wish insect control, they can select another band. Additionally, the consumer may combine scents, such as apples and cinnamon, to achieve the desired air treatment.

These and still other advantages of the present invention will be apparent from the description which follows and the accompanying drawings. In them reference is made to certain preferred example embodiments. However, the claims should be looked to in order to judge the full scope of the invention, and the claims are not to be limited to just the preferred example embodiments.

### BRIEF DESCRIPTION OF THE DRAWINGS

FIG. 1 is a perspective view of a first embodiment of the present invention;

FIG. 2 is a view similar to FIG. 1, except showing a peel-off cover in the process of being removed;

FIG. 3 is a partial sectional view taken along line 3-3 of FIG. 2;

FIG. 4 is a perspective view similar to FIG. 1, but of a second embodiment;

FIG. 5 is a partial sectional view along line 5-5 of FIG. 4;

FIG. 6 is a perspective view similar to FIG. 4 but of a third embodiment;

FIG. 7 is a vertical sectional view through a fourth embodiment showing how a candle can be mounted on a base with a surrounding outer sleeve to channel air flow along the sides of the candle; and

FIG. 8 is a perspective view similar to FIG. 1 of a fifth embodiment, but where the housing is frustum-shaped rather than cylindrical.

### DETAILED DESCRIPTION OF THE PREFERRED EMBODIMENTS

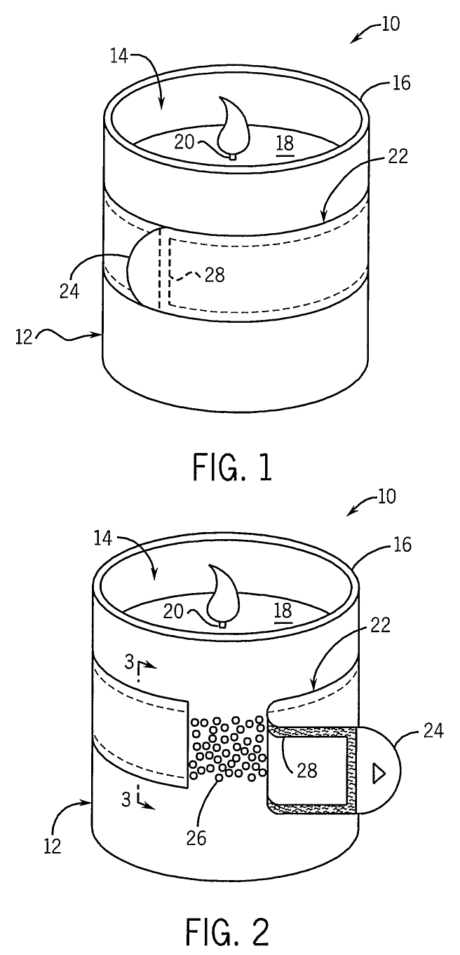

Referring first to FIG. 1, there is shown a candle generally 10 with a cylindrical housing 12 that is closed at the bottom and open at the top to form a cup-shaped internal cavity 14 having a radially peripheral exterior side wall 16. Housing 12 is preferably made of a high temperature resistant thermoplastic polyester resin such as one of the Valox family of resins sold by the General Electric Company, but may alternatively be produced from metal, ceramic, or any other suitable material. Where the candle also provides a light source, the material will preferably be transparent or translucent.

The candle 10 includes fuel, preferably wax 18, and an ignitable wick 20. Alternatively, the fuel may be any suitable other fuel such as butane, kerosene and the like.

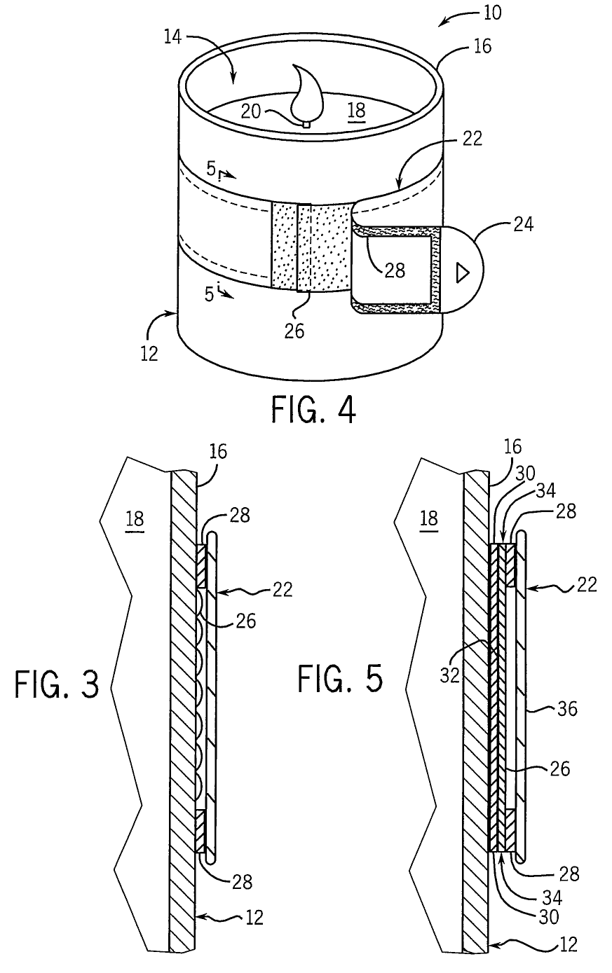

With particular reference to FIGS. 2 and 3, a sleeve-like band 22 is mounted to the outside of side wall 16 of the housing 12. The band 22 includes a gripping tab 24 for assisting in peeling the band 22 away from the side wall 16 to expose an air treatment chemical 26 adhered to the side wall between the side wall 16 and the band 22. The band 22 is preferably impermeable to the air treatment chemical 26 when present, such as being made of plastic (e.g., polyethyleneterephthalate) having a foil layer (e.g., aluminum foil). The combination of plastic and foil provides the appropriate structural strength and impermeability. However, other materials may be used which are strong enough to be handled during installation and prior to use, and which effectively seal the air treatment chemical 26 when present.

Peeling back the band 22 (as shown in FIG. 2) exposes the air treatment chemical 26 beneath. The air treatment chemicals 26 may be selected from a wide variety of formulations. See, for example, U.S. Pat. Nos. 6,309,986 and 6,337,080 for a disclosure of many volatile insect control materials, deodorizers, fragrances, and disinfectants known to be suitable for use with heating dispensers.

Typically there will be a hydrocarbon solvent having a high boiling point (as a carrier), one or more actives (e.g., an insecticide), and optionally an antioxidant and/or a fragrance. The formulation will be tailored for the application, and may have a variety of different ingredients as is conventional for the application.

Preferably, the air treatment chemical 26 includes a relatively high vapor pressure active such as metofluthrin or transfluthrin that are effectively delivered at temperatures of about sixty to seventy-two degrees Celsius. Also, as previously discussed, the air treatment chemical 26 may be air scents or deodorizers (e.g., fragrances or masks), pest control materials (e.g., insecticides, insect repellants, or insect growth control regulators), allergen control ingredients, disinfectants, mildew counteractant and the like.

In the first embodiment of FIGS. 1-3, the air treatment chemical 26 is preferably roll printed directly onto the radially outward portion of the exterior side wall 16 by conventional automated chemical printing techniques. Alternatively, it could be manually brushed on or applied by spraying, dipping, or the like. The band 22 is then mounted to the side wall 16 over the treated active and preferably continuing on to briefly overlap itself, adhering to the sidewall by use of an adhesive border 28 along the interior periphery of the band 22, leaving the tab 24 to aid in peeling off the band 22. Alternatively, the band 22 may be mounted to the side wall 16 of the housing by heat sealing or removably secured in a like manner. In any event, in this embodiment the band 22 creates a seal to prevent the air treatment chemical 26 from volatizing before desired.

In use, the band 22, or seal, is peeled away from the side wall 16 of the housing 12 by pulling on the tab 24. Once removed, the air treatment chemical 26 is exposed to the outside air and will, begin to volatize, particularly when the candle is lit. In this regard lighting the wick 20 of the candle 10 to combust the wax 18 generates heat. The heat is transferred through the side wall 16 to the adjacent air treatment chemical 26, causing the air treatment chemical 26 to volatize at an increased rate, thus dispensing more air treatment chemical 26 into the surrounding atmosphere. In this form, the candle 10 is preferably a one-time use disposable candle 10, such that the amount of air treatment chemical 26 and its volatilization characteristics are preferably correlated to the use-up burn time of the candle 10.

The wax 18 may too have mixed therein an additional air treatment chemical that is either similar to or distinct from the air treatment chemical 26 located on the side wall 16. This allows a consumer to combine fragrances (e.g., apple scent in the wax 18 with cinnamon scent in the air treatment chemical 26), have a fragrance in the wax 18 and an insect repellant in the air treatment chemical 26, have a synergist in the air treatment chemical and an insecticide in the wax, and a multitude of other combinations.

Turning to FIGS. 4 and 5, a second embodiment is depicted. In this embodiment, the band 22 is multi-layer strip that can be mounted to the side wall 16 as a single unit. A layer of the band 22 is still capable of being peeled off (as shown in FIG. 4) with the aid of a tab 24. However, in this case the band 22 has other layers that will remain affixed to the housing 12 when this occurs. With specific reference to FIG. 5, the band 22 includes an adhesive layer 30, and inner layer 34, an adhesive border 28, and an outer layer 36.

The band 22 may be mounted to the candle 10 by the adhesive layer 30 adjacent the inner side 32 of the inner layer 34. The adhesive layer 30 may further include a peel-off cover (not shown) to protect the adhesive until adhesion is desired (analogous to a Band Aid type configuration).

The band 22 includes an adhesive border 28, except the adhesive border 28 is not adjacent the side wall 16, but is adhered to the perimeter of the interface between the outer layer 36 and the inner layer 34. This provides a seal sealing the air treatment chemical 26 to prevent unwanted volatizing.

The outer layer 36 can be peeled away from the inner layer 34 exposing the air treatment chemical 26. In this example embodiment, the air treatment chemical 26 is preferably impregnated into the inner layer 34. Alternatively, the inner layer 34 may include a substrate that has an air treatment chemical 26 printed thereon, similar to the first example embodiment, or otherwise attached thereto by a mat, pad, or film made of cellulose, polyethyleneterephthalate, and the like.

The second embodiment operates similar to the first once the band 22 has been affixed to the candle 10 by an adhesive or any other suitable method. To affix the band 22, the adhesive layer 30 of the band 22 is exposed and the band 22 is placed into contact with the side wall 16 of the housing 12. While the adhesive layer 30 is depicted as covering the entire inner side 32 of the inner layer 34, the area of the adhesive layer 30 may be reduced to provide a smaller contact area between the adhesive layer 30 and the side wall 16.

When dispersion of the air treatment chemical 26 is desired, the outer layer 36 of the band 22 is peeled from the inner layer 34 as the adhesive border 28 releases, exposing the air treatment chemical 26. Again, the heat generated by lighting the wick 20 is transferred through the side wall 16 to the adjacent air treatment chemical 26, causing the air treatment chemical 26 to volatize at an increased rate, thus dispensing air treatment chemical 26 into the surrounding atmosphere.

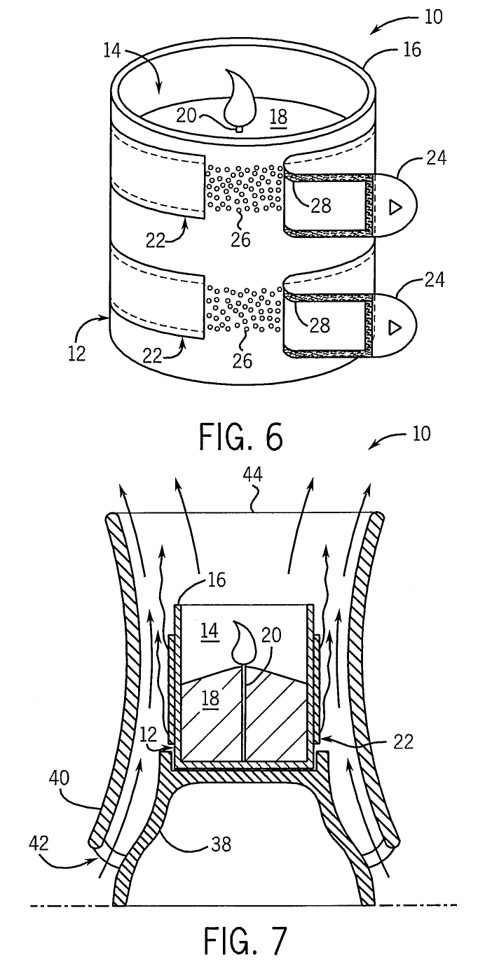

With reference to FIG. 6, a third embodiment of the present invention is shown. It is similar to the first embodiment except that now there is a pair of bands 22 mounted to the side wall 16 of the candle 10, providing two different air treatment chemicals 26. This is an embodiment that might be particularly suitable when neither chemical can be stored with each other for a long period, and neither is suitable to be burnt in the wax.

A fourth example embodiment is depicted in FIG. 7. While the previous embodiments illustrated bands 22 of relatively narrow widths in comparison to the candle 10 (e.g. to facilitate light through the side walls), the fourth embodiment clearly illustrates that the band 22 may be of greater widths, or completely cover the side wall 16.

Note that FIG. 7 discloses that such candles can be placed on a base 38 surrounded by a sleeve 40 with lower openings 42. This assembly directs a vigorous flow of air along the sides of the band and then out an upper opening 44. This chimney effect helps disperse the air treatment chemical 26 into the surrounding atmosphere. Alternatively, this candle 10 may optionally also include legs (not shown) at the base of the housing 12 to allow air to cool the bottom of the housing 12.

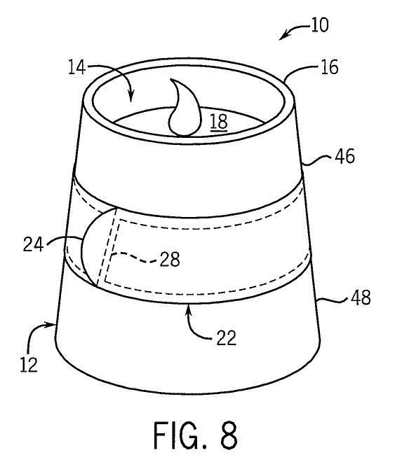

A fifth example embodiment is shown in FIG. 8 in which the housing 12 is conical. In this case the band 22 is sized to slideably engage the side wall 16 such that moving the band 22 from the smaller upper end 46 to the larger lower end 48 removably wedges the band 22 onto the candle 10 without the need for any adhesives.

When the band 22 of the preceding embodiment (shown in FIG. 8) is used, bands 22 may be quickly and easily exchanged by simply sliding one band 22 off of the housing 12 and sliding another band 22 onto the housing 12. For example, a first band 22 may be placed on the housing 12 and have an air treatment chemical 26 providing a flower scent. Perhaps later in the day, the consumer wishes to move the candle 10 to the backyard where mosquitoes may be prevalent. The consumer may exchange bands 22 and place a band 22 having as the air treatment chemical 26 an insect control agent.

While the above describes a number of preferred example embodiments, it should be appreciated that other embodiments are also within the scope of the invention. For example, other housing 12 shapes and configurations are within the scope of the invention. The housing 12 may have a rectangular cross-section, as viewed from above. Also, a variety of other profiles and shapes will lend themselves to application of the present invention.

Thus, the claims that follow should be looked to in order to judge the full scope of the invention.

### INDUSTRIAL APPLICABILITY

The present invention provides a candle for dispensing an air treatment chemical and a band selectively sealing the air treatment chemical.

1. An article for dispensing an air treatment chemical, the article comprising:
a housing having an exterior side wall structure and an internal cavity in which is positioned a combustible fuel;
an air treatment chemical mounted on a radially outward portion of the exterior side wall structure in a position where it can be heated through the exterior side wall structure by the fuel when the fuel is combusted; and
a seal positioned over the air treatment chemical to inhibit dispensing of the air treatment chemical prior to combustion of the fuel, and removable there from to permit said dispensing of the air treatment chemical when the fuel is combusted.

2. The article of claim 1, wherein the fuel is wax and the article is in a form of a candle.

3. The article of claim 1, wherein the air treatment chemical is selected from the group consisting of volatile insect control agents, volatile fragrances, and volatile deodorizers.

4. The article of claim 1, wherein the fuel has mixed therein an air treatment chemical that is different from the air treatment chemical mounted on the radially outward portion of the exterior side wall structure.

5. The article of claim 4, wherein the air treatment chemical mixed in the fuel is a fragrance and the air treatment chemical mounted on said radially outward portion of the exterior side wall structure is an insect control agent.

6. The article of claim 1, wherein an air treatment chemical has been applied to the exterior side wall structure by a printing process.

7. The article of claim 1, wherein the seal is in a form of a band having a peel-off portion.

8. The article of claim 7, wherein the band has multiple layers, an outer seal layer is capable of peeling off from an inner layer, and the inner layer comprises an air treatment chemical.

9. The article of claim 8, wherein an air treatment chemical has been applied to the inner layer of the band by a printing process.

10. The article of claim 8, wherein the inner layer has positioned on its inner side an adhesive for mounting the band on the exterior side wall structure.

11. The article of claim 10, wherein the air treatment chemical applied to the inner layer is an insect control agent.

12. The article of claim 1, wherein the housing is cylindrical.

13. The article of claim 1, wherein the housing is essentially rectangular in top view.

14. The article of claim 1, wherein the housing is at least partially frustum-shaped.

15. The article of claim 1, wherein the housing is partially surrounded by a sleeve to enhance said dispensing of the air treatment chemical when the fuel is combusted.

16. The article of claim 15, wherein the housing is supported by a base.

17. The article of claim 1, wherein the seal comprises a foil layer.

18. An article for dispensing an air treatment chemical, the article comprising:
a housing having an exterior side wall structure and an internal cavity in which is positioned a combustible fuel; and
an air treatment chemical mounted on a radially outward portion of the exterior side wall structure in a position where it can be heated through the exterior side wall structure by the fuel when the fuel is combusted.

19. A kit for selectively treating air in a room with alternative air treatment chemicals, the kit comprising:
a housing having an exterior side wall structure and an internal cavity in which is positioned a combustible fuel;
a first band and a second band, wherein both bands have an air treatment chemical mounted thereon, the air treatment chemical on the first band being a different air treatment chemical than that on the second band;
both bands having a seal positioned over their air treatment chemical to inhibit dispensing of their air treatment chemical prior to combustion of the fuel, and removable there from to permit said dispensing of an air treatment chemical when the fuel is combusted;
wherein the bands are alternatively positionable around the exterior side wall structure so as to be in a position where they can be heated through the exterior side wall structure by the fuel when it is combusted.

20. An article for dispensing an air treatment chemical, the article comprising:
a housing having a side wall structure and an internal cavity in which is positioned a combustible fuel; and
an air treatment chemical mounted on a radially outward portion of the side wall structure in a position where it can be heated through the side wall structure by the fuel when the fuel is combusted;
wherein the housing is partially surrounded by a sleeve to enhance said dispensing of the air treatment chemical when the fuel is combusted.

21. The article of claim 20 wherein there is a seal positioned over the air treatment chemical to inhibit dispensing of the air treatment chemical prior to combustion of the fuel, and removable there from to permit said dispensing of the air treatment chemical when the fuel is combusted.
